(19) United States
(12) Patent Application Publication
(10) Pub. No.: US 2019/0378097 A1
(43) Pub. Date: Dec. 12, 2019

(54) SOCIAL MEDIA PLATFORM WITH RECOGNITION TOKENS

(71) Applicant: GIVEL CO PBC, San Jose, CA (US)

(72) Inventor: Gregory Roberson, San Jose, CA (US)

(21) Appl. No.: 16/476,822

(22) PCT Filed: Jan. 9, 2018
(86) PCT No.: PCT/US18/12975

§ 371 Date: Jul. 9, 2019

Related U.S. Application Data
(60) Provisional application No. 62/443,869, filed on Jan. 9, 2017.

(51) Int. Cl. G06Q 20/06; G06Q 50/00; G06Q 20/36; G06Q 30/02

(52) U.S. Cl. CPC G06Q 20/0658; G06Q 30/0239; G06Q 20/3672; G06Q 50/01

(57) ABSTRACT

In one embodiment, a social media platform allows users to give and receive “recognition tokens” (or other exchanged units of recognition), in addition to mere appreciation indications (e.g., “likes”), such that a first user may only give a recognition token to a second user if the first user has a recognition token to give. Users may give recognition tokens to other users/entities in response to deeming particular activities (e.g., posts, etc.) worthy of receiving more than a mere appreciation indication (e.g., “liking” something) that is unlimited, but instead being worthy of being given a recognition token of which the user has a limited quantity. In addition to receiving recognition tokens from other users, users may also receive recognition tokens based on bonuses, gifts, exchanges, etc. In one illustrative non-limiting use-case embodiment, the social media platform may be based on awarding recognition tokens in response to good deeds, kind acts, etc.

### RELATED APPLICATIONS

This application claims priority to U.S. Provisional Application No. 62/443,869 filed Jan. 9, 2017, entitled “SOCIAL MEDIA PLATFORM WITH RECOGNITION TOKENS,” by Gregory Roberson, the contents of which are hereby incorporated by reference.

### TECHNICAL FIELD

The present disclosure relates generally to social media platforms, and, more particularly, to social media platforms with recognition tokens or other exchanged units of recognition.

### BACKGROUND

Social media platforms, such as FACEBOOK, PINTEREST, INSTAGRAM, LINKEDIN, and so on, are all generally premised on users sharing content or “posts” for other users (e.g., “friends”, “connections”, the public, etc.) to view. Posts may include text, pictures, videos, and other content (e.g., locations, emotions, tagged users, etc.), and users viewing the posts can usually comment on the post, share it with other users, pin the post to their personal page, or click on various levels of appreciation for the post, such as “liking” the post, or, more recently, “loving” the post, “laughing at” the post, “crying at” the post, etc., such as based on clicking various emojis, ideograms, emoticons, and so on. The number of users viewing a post, or more particularly “liking” or sharing a post, may then be shown, indicating to viewers the general popularity and appreciation for the post.

### SUMMARY

According to one or more embodiments herein, a social media platform is described where, in addition to merely posting content and indicating appreciation for certain posts, users are allowed to give and receive newly defined “recognition tokens” (or other exchanged units of recognition), such that a first user may only give a recognition token to a second user if the first user has a recognition token to give. Users may give recognition tokens to other users (or organizations, events, or other entities) in response to deeming particular activities (e.g., posts, challenges, general entity purpose, etc.) worthy of receiving more than a mere appreciation indication that is unlimited (e.g., more than simply “liking” something). That is, the activity is instead deemed worthy of being giving a recognition token of which the user has a limited quantity. In addition to receiving recognition tokens from other users, users may also receive recognition tokens based on bonuses (e.g., signing up, completing tasks, etc.), gifts, exchanges, and so on.

In one illustrative use-case embodiment, the social media platform may be based on recognition tokens that are awarded in response to good deeds, kind acts, and so on. However, the embodiments herein are not so limited, and any suitable use-case for recognition tokens may advantageously utilize the techniques described herein.

In addition, the description herein demonstrates example systems and computer architectures that may be configured to implement the techniques herein, such as various token repository servers, social medial platform servers, graphical user interfaces (GUIs), and so on.

Notably, this summary is meant to be illustrative of certain example aspects and embodiments of the detailed description below, and is not meant to be limiting to the scope of the present invention herein.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example of transferring recognition tokens in a social media platform with recognition tokens according to the techniques herein;

FIG. 2 illustrates an example of not transferring recognition tokens in a social media platform with recognition tokens according to the techniques herein;

FIG. 3 illustrates a simplified example procedure for transferring recognition tokens in a social media platform with recognition tokens according to the techniques herein;

FIG. 4 illustrates an example user interface for viewing a repository of recognition tokens according to the techniques herein;

FIG. 5 illustrates an example user interface for viewing and accepting recognition-token-based challenges according to the techniques herein;

FIG. 6 illustrates an example user interface for transferring recognition tokens according to the techniques herein;

FIG. 7 illustrates an example user interface for badges earned based on recognition tokens according to the techniques herein;

FIG. 8 illustrates a simplified example procedure for use with a social media platform with recognition tokens according to the techniques herein;

FIG. 9 illustrates an example computer network within which a social media platform with recognition tokens may operate according to the techniques herein; and

FIG. 10 illustrates an example computing device for use with a social media platform with recognition tokens according to the techniques herein.

### DESCRIPTION OF EXAMPLE EMBODIMENTS

As noted above, social media platforms allow users to click on various levels of appreciation for a post, such as “liking” the post, “loving” the post, “laughing at” the post, and so on, where the number of users viewing, liking, or sharing a post may then be indicated to demonstrate a post's overall popularity. However, with current social media platforms, users are free to “appreciate at-will”, meaning their ability to like, share, pin, etc. is unlimited, and thus there is no inherent cost to the user for appreciating a post. For instance, imagine a kid in a candy store, with unlimited funds: he/she can just like (and buy) everything. This is the current standard of social media networks: like (click on) anything you want. While this standard is certainly acceptable and useful (knowing who likes what, how many users liked a certain post, etc.), it is missing one key element: value.

As mentioned above, according to one or more embodiments herein, a social media platform is described herein where, in addition to merely posting content and indicating appreciation for certain posts, users are allowed to give and receive newly defined “recognition tokens” (or other exchanged units of recognition). For instance, a first user may only give a recognition token to a second user if the first user has a recognition token to give. Users may give recognition tokens to other users (or organizations, events, or other entities) in response to deeming particular activities (e.g., posts, challenges, general entity purpose, etc.) worthy of being giving a recognition token, of which the user has a limited quantity. This is different than giving a mere appreciation indication (e.g., “liking” something), since such appreciation indications are unlimited, and as such have little to no true value. As described below, in addition to receiving recognition tokens from other users, users may also receive recognition tokens based on bonuses (e.g., signing up, completing tasks, etc.), gifts, exchanges, and so on.

Social media networks/platforms, generally, are well understood by those skilled in the art, such as sharing, liking, commenting, and so on. The embodiments herein, therefore, will be described with reference generally to typical terms of art for use with existing social media networks, or else as a standalone (newly created) social media network whose premise is based on the exchange of recognition tokens (e.g., the illustrative “good deeds” social media platform described in the use-case below).

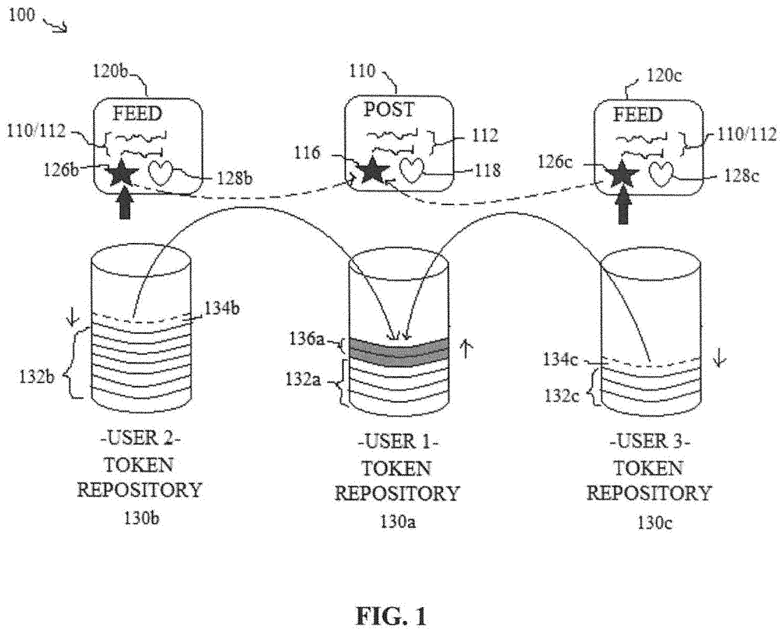

As shown in the token exchange environment 100 of FIG. 1, a first user “User 1”, such as a person, an entity, an organization, etc. (e.g., “poster”), may create a post 110 on a social media network with content 112, such as text, a picture, a video, and so on (e.g., with locations, tagged users, etc.), as will be readily understood by those skilled in the art. Assume for simple illustration that a post 110 has a “like” indication 118 (e.g., the illustrated heart) and a novel “recognition token” indication 116 (e.g., the illustrated star). This post 110 may then be shared with other users (e.g., publicly, through contacts or “friends” of User 1 only, and so on), and will appear on the feeds 120 (e.g., graphical user interfaces or “GUIs”) of other users (e.g., “viewers”), such as User 2 (120b) and User 3 (120c), as shown. Each post on a user's feed may thus have clickable icons for liking (e.g., a heart 126) the post and for loving or otherwise deeming the post worthy of a recognition token (e.g., star 128).

Also associated with each user is a corresponding “token repository” 130, such as a database of token amounts (earned, gifted, etc., described herein). The repository 130 for each user may be stored locally, or else on a centralized server, or on a particular server corresponding to the user (distributed server systems), and keeps track of the number of tokens 132 currently held by each particular user (e.g., 132a for User 1, 132b for User 2, and 132c for User 3).

According to the techniques herein, when users (e.g., User 2 and User 3) click on the illustrative star 126 (b or c) as shown by the larger arrows, a transferred recognition token 134 may be taken from their respective token repository 130 (b or c), and placed into the repository of the posting user (e.g., 130a of User 1) as newly earned tokens 136a (thus being added to the currently available tokens 132a of User 1, accordingly). Similar to conventional social media platforms, the number of tokens earned (received) by the poster (e.g., User 1) for that particular post may be shown on the post itself, such as a number associated with the star icon 116. (Other information, such as names of posters, numbers of likes, shares, comments, etc., may also be shown, as will be appreciated by those skilled in the art.)

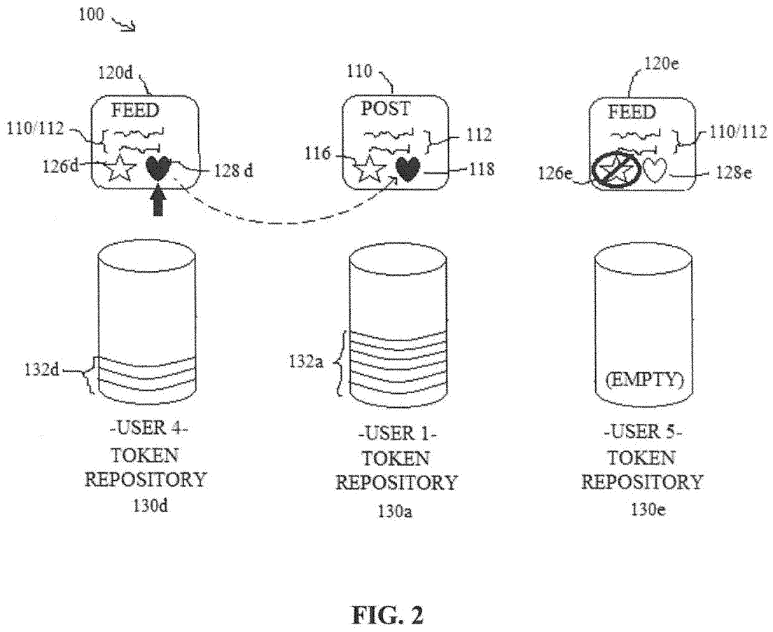

As shown in FIG. 2, assume that two other users (e.g., User 4 and User 5) also see the post 110 (e.g., from User 1) on their feeds (120d and 120e, respectively). However, User 4 may only like the post, clicking the heart icon 128d, and as such, no recognition tokens are transferred from User 4 to User 1, and the number of likes/hearts 118 may be increased on the post 110. User 5, on the other hand, may have no recognition tokens in his/her token repository. For example, User 5 may not have yet received any tokens, or may have given away (e.g., “spent”) all of his/her tokens to other users. As such, User 5 does not have the option to give any additional tokens until replenishing his/her supply, such as through receiving recognition tokens from other users (e.g., for posts or else as gifts, as described below), or in certain embodiments, by purchasing more tokens from the social media platform. Accordingly, User 5 would either be prevented from clicking the illustrative star icon 126e, or else may be able to click it and receive an error message or other message indicating the depleted token supply.

Of course, a user/viewer can simply read (or, depending on the social media platform, quickly scroll right past . . . ) the post, without either liking the post or granting any recognition tokens (e.g., stars) for the post.

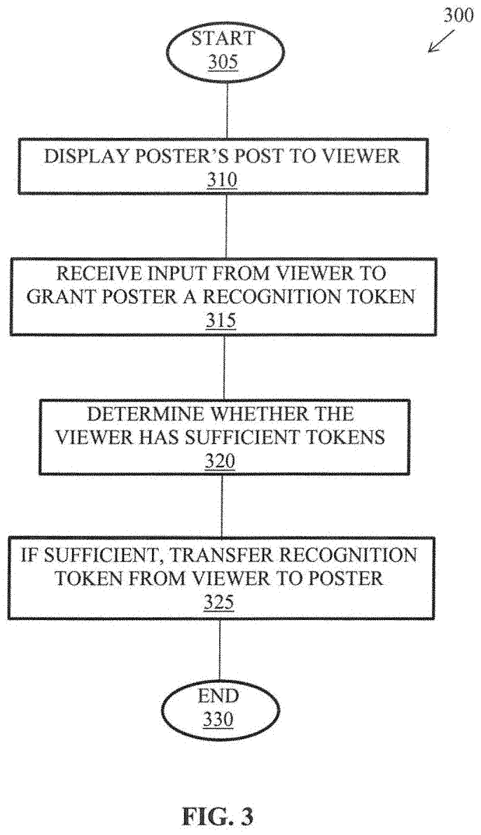

FIG. 3 illustrates an example high-level procedure 300 for use with a social media platform with recognition tokens. For instance, the simplified procedure 300 starts in step 305, and continues to step 310 where the system (e.g., servers) displays a post from a “poster” (e.g., a user, an entity, etc., that provides content as posts to the social media platform) to a viewer (e.g., another user), such as on the viewer's feed. If the viewer desires to grant a recognition token to the poster, then in step 315 the system receives such an input from the viewer (e.g., clicking on a token icon). As such, the system may then determine in step 320 whether the viewer has sufficient tokens (e.g., one token, or more if gifting a plurality of tokens at once) in his/her token repository, such that if so, then in step 325 the recognition token(s) is/are transferred from the viewer to the poster, and the simplified procedure ends in step 330.

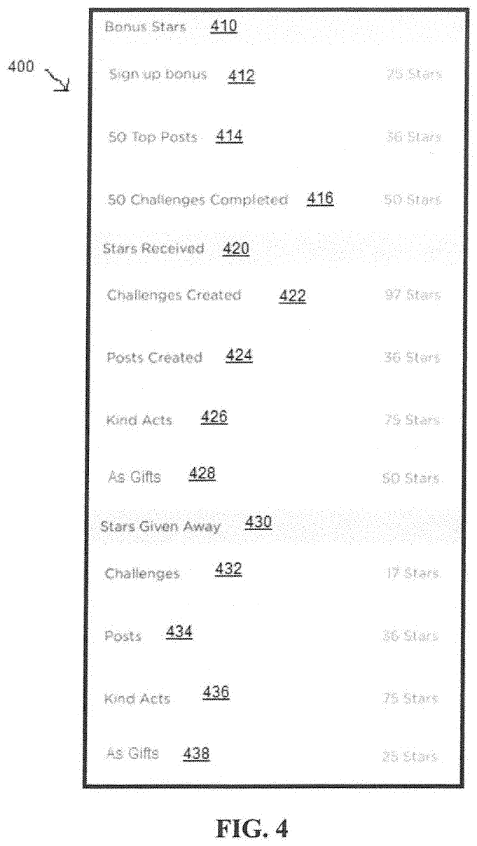

FIGS. 4-7 illustrate certain aspects of the present disclosure in relation to example use-case embodiments. In particular, as shown in FIGS. 4-7, one example social media platform with recognition tokens herein may be based on the tokens being awarded or otherwise distributed and exchanged in response to good deeds, kind acts, and so on. That is, a social media network (app, servers, content, GUIs, programs, etc.), may establish a social community of giving, allowing users to earn recognition tokens by posting great content or participating in a kind act. Note, of course, that the embodiments herein are not so limited, and any suitable use-case for recognition tokens may advantageously utilize the techniques described herein. That is, the social community of giving is merely one example embodiment that is not meant to limit the scope of the present disclosure.

As an example, when a user joins the social media network, they may be given an initial number of recognition tokens or “stars”, e.g., 25. A star, as mentioned above, is a form of “social currency”; it can be earned and shared like a real currency. Users can earn more stars by posting great content or, in the specific use-case example above, by participating in a kind act. Note that new users may create a user profile to be stored at a host server, or else the system may integrate one or more other social network services and access the same information via a social networking profile belonging to the initiating user. By integrating social networking services (e.g., a FACEBOOK account), the initiating user may login using his or her social network credentials to a) verify his or her identity, and b) access a list of contacts/friends, as well as friends of friends. It should be understood that the processes for logging in, storing personal information, authenticating a user, and so forth, may be configured in any manner suitable for creating and/or authenticating the user and accessing basic information of the initiating user.

FIG. 4 illustrates an example token repository GUI, or “bank” 400. The bank may be configured to show the user's recognition tokens (e.g., number of stars) and how those tokens/stars were earned. For example, stars may have been received due to various bonuses 410 (e.g., sign-up bonus 412 as mentioned above, as well as top posts 414, challenges completed 416, and so on), tokens received 420 (e.g., from challenges created 422, posts created 424, kind acts completed 426, tokens gifted from contacts 428, and so on). It also shows the number of tokens/stars given away (430) and where they were shared (e.g., challenges 432, posts 434, kind acts 436, given as gifts 438, etc.).

As noted above with reference to FIGS. 1-2, when a user sees something on their feed, they have the ability to like the post (e.g., the heart icon or other icon such as a thumbs-up icon, etc.), or if they really love the post, they can give one or more stars as a way of saying “awesome” or “I REALLY love this”. Note that the user's feed may be based on friends, contacts, or other entities (e.g., charities, organizations, groups, etc.) that are being “followed”, or else in another option (or embodiment), the feed may show “community” posts, such as those based on location (e.g., nearby regions, cities, states, etc.) or other communities (e.g., colleges or universities, sports clubs, and so on).

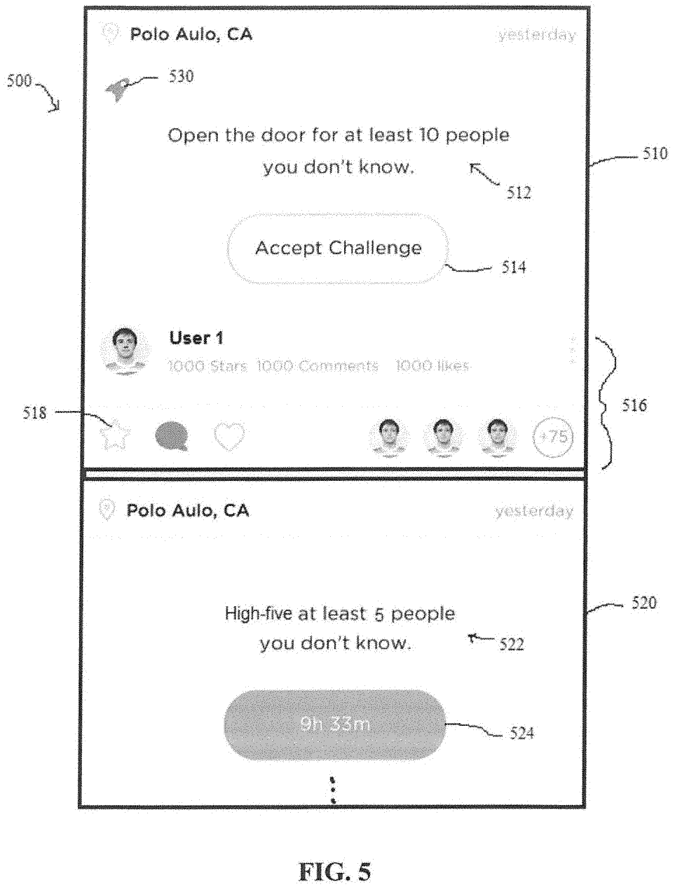

According to one or more embodiments herein, particularly with regard to the present use-case, as shown in the feed 500 of FIG. 5, tokens/stars can also be given to others based on “challenges” when they discover a challenge they love or else received upon completion of a challenge. For instance, challenges may be created by the social media platform provider, or else by other users or entities, and are meant to challenge users to perform certain tasks (e.g., acts of kindness in the illustrative use-case example mentioned above). For example, a town may challenge users in that town to perform trash pickup in the park, or to plant a tree in their yard, or to just simply open doors for a certain number of strangers. Other types of challenges may be to pay for someone's coffee in line, help an elderly citizen with their bags up a flight of stairs, and so on. Feed entry 510 illustrates an example challenge text 512, with an icon/button 514 that a user may press to accept that challenge (e.g., “open the door for at least ten people you don't know”). Once a user accepts the challenge (e.g., as shown in feed entry 520, “high-five at least five people you don't know”), they may have a certain amount of time 524 in which to complete the challenge 522 in order to receive any tokens/stars for their efforts. Recognition tokens earned in response to completing challenges may be taken from the creator's repository of tokens (e.g., “if you complete this, I will give you X tokens from my repository”), or else may be newly generated by the social media platform (e.g., “if you complete this, the social media platform will add X to your repository”).

Note that other information fields 516 within the GUI may illustrate the creator/source of the challenge, the users who have accepted or completed the challenge, or simply a number of people who have accepted/completed the challenge. Also, token/star icon 518 may be used in the same manner as described above with reference to posts in order to give a recognition token to the creator of the challenge. Other indicators, such as the illustrative “rocket” icon, may indicate to users that a particular challenge is really taking off (e.g., going viral).

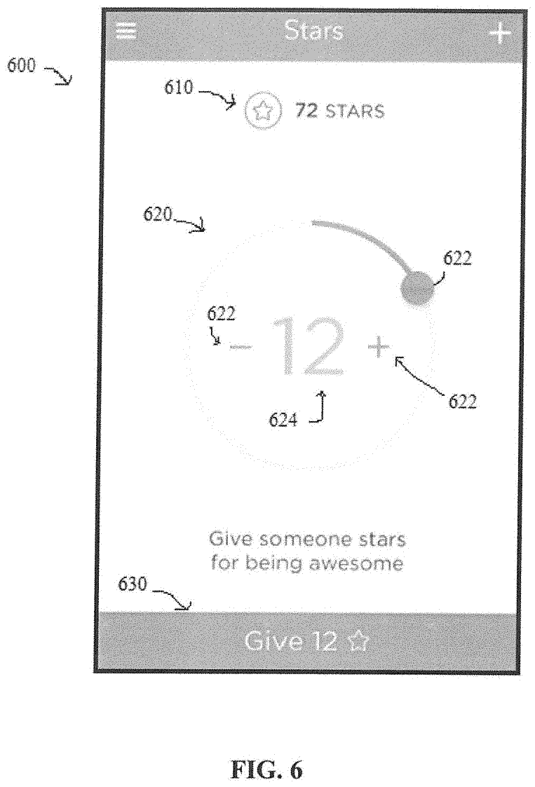

According to one embodiment, as long as there are stars in the user's account, they can easily be given to others. For instance, as shown in the simplified token bank user interface 600 of FIG. 6 (e.g., where a user may see the number of tokens/stars 610 they have by clicking on a star icon/glyph at a bottom menu bar), once selecting the number of tokens/stars to give away using the GUI 620 (e.g., selectors 622, such as sliders, wheels, +/−, etc.), then that number of tokens/stars 624 may be given to anyone of the user's choosing (e.g., by selecting confirmation button 630, and then selecting the desired recipient).

For instance, if a user wants to give stars to someone on the same social network, they can do so by sharing stars directly through the social media platform app. Alternatively, tokens/stars can also be given to those who are not yet signed up on the social media network. One option is to send stars through a user's contacts, which may be derived from contacts stored on the user's device (e.g., on a smartphone), or else based on contacts collected from other social media networks (e.g., FACEBOOK), thus leveraging pre-existing information from other networks. For example, the techniques herein may be configured to send tokens/stars through the other social media network, or through email, or via a text message, optionally with an invite to join the community, along with a code or link granting access to the transferred tokens. It should be understood that the giving user may select the target (recipient) user in any suitable manner, and the above examples are merely for demonstration purposes.

According to a particular aspect of the techniques herein, a user can find a collection of organizations/entities, such as non-profits, charities, socially responsible organizations, hobby or enthusiast pages, fan pages, brand names, stores, products, sports teams, and so on, such as for other use-cases (e.g., as mentioned below). In the spirit of the recognition token exchange herein, users can give these organizations tokens/stars, as well. For instance, in one embodiment, for every star an organization receives, the organization may receive a free ad “impression”, or view, on the main feed. Alternatively, organizations may compete for a number of stars in order to receive funding, such as determining which charity deserves monies from a limited-resource philanthropic foundation. Once an organization's impression (view) is on the Feed, users can then interact with the organization through comments and likes, as well as by giving them more stars.

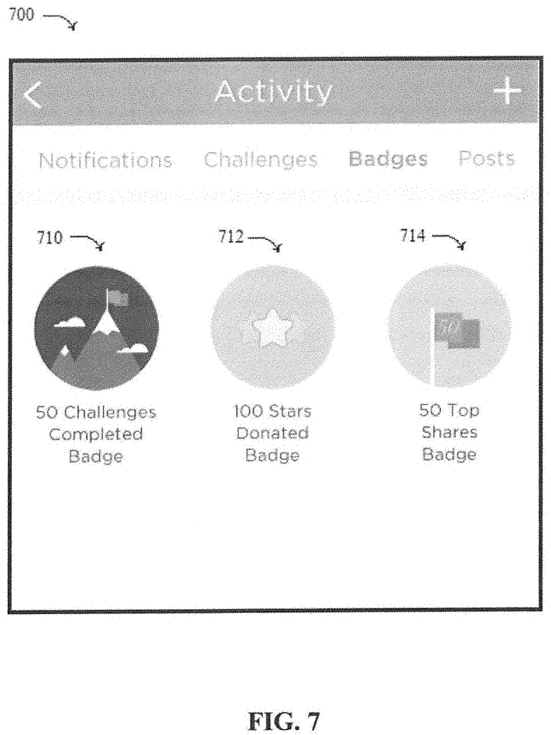

FIG. 7 illustrates another aspect of one or more embodiments herein, where various “badges” 700 or awards may be granted to users, such as, e.g., completing fifty challenges (710), donating one hundred stars (712), sharing fifty of the top posts over a given time (714), and so on. Badges (or other awards) may merely be for achievement recognition, or may also be associated with certain awards of recognition tokens. For example, achieving a badge or other milestone may result in the grant of additional (e.g., 10, 25, etc.) recognition tokens to distribute.

Note that in another embodiment herein, the platform may be configured to allow users to trade or “purchase” various online items within the platform, such as “stickers” with their tokens. For instance, stickers may represent virtual representations (e.g., images, icons, graphics, and so on) in addition to badges that a user could either place on his/her own profile, or else to give to someone else for their profile. For example, assume a first user purchases a virtual sticker (e.g., using 10 of his tokens/stars) that says “You're incredible”, and then sends that virtual sticker to another user through the app, or placing it (e.g., posting) into the other user' profile. As another example, assume a second user purchases a virtual sticker (e.g., using 10 of her tokens/stars) that is an image displaying the shape of a safety pin, and places it on her profile to signify solidarity.

Note that while the description and figures above illustrate certain aspects of the present invention in relation to a very specific use-case example of a community of good will and giving, alternative embodiments and use-cases certainly could exist that may take advantage of the recognition tokens herein, without departing from the scope of the present invention described herein. For instance, social media networks may be based on hobby groups, such as, for example, automotive enthusiasts recognizing certain modifications, robotics enthusiasts recognizing certain designs or accomplishments, artist communities recognizing great art/music/etc., outdoor enthusiasts recognizing outdoor activity achievements, and so on. Other types of communities may also use a recognition token exchange, such as start-up/entrepreneur communities (e.g., which idea should proceed, which innovation should be awarded, etc., similar to KICKSTARTER but without the cash investment), or any other kind of online community where users would want to give recognition above and beyond mere appreciation indications, and generally only where those users themselves have done something to get recognition tokens in the first place.

The techniques described herein, therefore, provide generally for a social media platform with recognition tokens. Advantageously, the embodiments herein create a new social media platform, or expand conventional social media platforms, with a limited resource that can be exchanged among users or other entities, thus creating a “social media currency” that has value and meaning beyond the unlimited ability to like, share, pin, link, emote, etc. Though certain use-cases and their associated advantages have been described above, it should be noted that the opportunity for other types of social media networks/platforms to use recognition tokens in this manner may provide additional advantages than those mentioned herein.

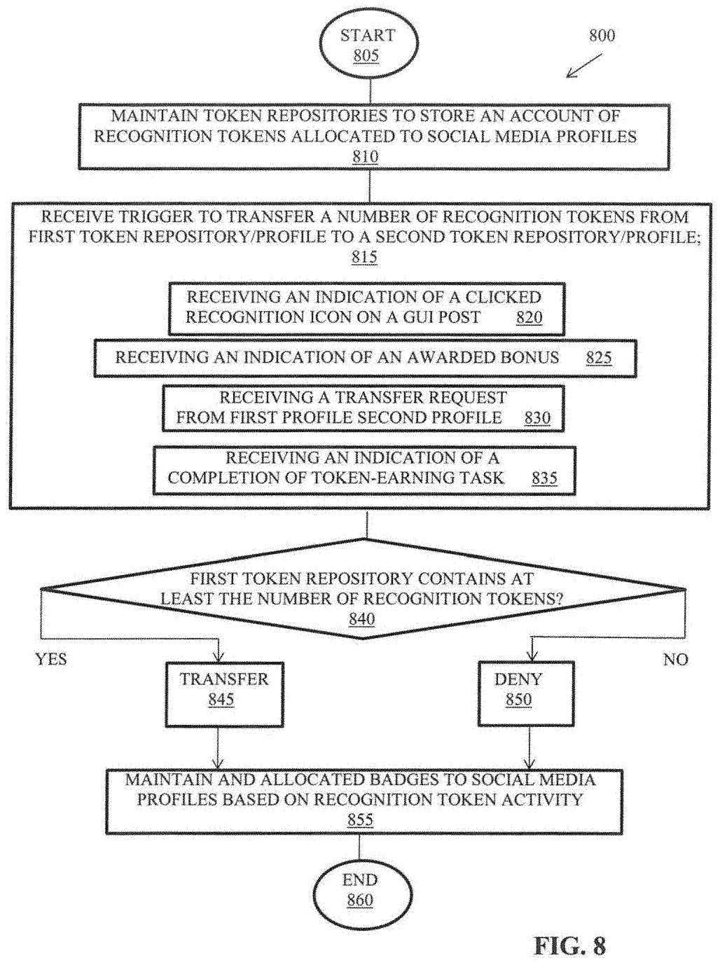

FIG. 8 illustrates an example simplified procedure for use with a social media platform with recognition tokens according to the techniques herein. For example, a non-generic, specifically configured device may perform procedure 800 by executing stored instructions (e.g., a process). The procedure 800 may start at step 805, and continues to step 810, where, as described in greater detail above, a computing device (e.g., server) maintains a plurality of token repositories associated with a plurality of social media profiles on a social media platform, the token repositories configured to electronically store an account of recognition tokens allocated to each particular social media profile of the plurality of social media profiles. In step 815, the computing device may then receive a “trigger” to transfer a number of recognition tokens from a first token repository associated with a first social media profile to a second token repository associated with a second social media profile (e.g., a human user or an organization).

Notably, as described above, the trigger for the transfer may be the result of several different actions. First, in step 820, the trigger is based on receiving an indication of a clicked recognition icon on a post within a GUI of the social media platform from the first social media profile (e.g., clicking a star on a post, and as such, the number of tokens to give is one). Alternatively, in step 825, the trigger is based on receiving, from the social media platform, an indication that the second social media profile is being awarded a bonus of the number of recognition tokens by the social media platform (e.g., a sign-up bonus, a task/challenge completion bonus, a congratulatory (e.g., birthday, anniversary, etc.) bonus, and so on). As still another option, in step 830, the trigger may be based on specifically receiving a transfer request (e.g., giving/gifting tokens) from the first social media profile to transfer the number of recognition tokens to the second social media profile. For instance, the computing device may receive input from a GUI of the social media platform from the first social media profile, where the input comprises a selected number of recognition tokens to transfer to the second social media profile as a selected recipient of the transferred recognition tokens. Note that in certain instances, the transferee is simply a contact of the first social media profile (e.g., that has not yet joined or signed up for the social media platform), and as such, the computing device may transfer the selected number of recognition tokens to the second social media profile in response to the contact signing up to the social media platform as the second social media profile, as described above. Lastly, in step 835, the trigger may be based on receiving an indication of a completion, by the second social media profile, of a token-earning task (e.g., challenge) presented within the social media platform (e.g., as created by the first social media profile, or, notably, as created by a third social media profile, where the first social media profile and first token repository are associated with an administrator account for the social media platform).

Accordingly, in step 840, the computing device may then determine whether the first token repository contains at least the number of recognition tokens. In response to the first token repository containing at least the number of recognition tokens, the computing device may then transfer the number recognition tokens from the first token repository to the second token repository in step 845. Otherwise, in response to the first token repository containing less than the number of recognition tokens, then in step 850 the computing device denies the transfer of the number recognition tokens from the first token repository to the second token repository.

As an additional and optional step 855, the computing device may also maintain, with the plurality of social media profiles, a list of badges allocated to each particular social media profile of the plurality of social media profiles, and allocates the badges based on recognition token activity. For example, as described above, the recognition token activity may be such things as surpassing a threshold number of tokens earned, surpassing a threshold number of tokens given, surpassing a threshold number of tokens earned, surpassing a threshold number of token-earning tasks, and so on.

The illustrative and simplified procedure 800 may then end in step 860, notably with the option to continue receiving and processing token transfer triggers, accordingly.

It should be noted that while certain steps within procedure 800 may be optional as described above, the steps shown in FIG. 8 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

Illustratively, the techniques described herein may be performed by hardware, software, and/or firmware, such as in accordance with the various processes of user devices, servers, network devices, and so on, which may contain computer executable instructions executed by processors to perform functions relating to the techniques described herein. That is, various systems and computer architectures may be configured to implement the techniques herein, such as various token repository servers, social medial platform servers, graphical user interfaces (GUIs), and so on.

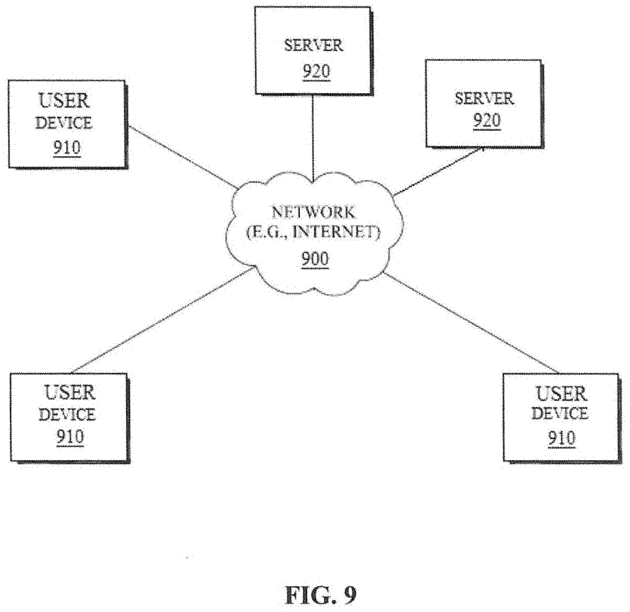

For example, a computer network is a geographically distributed collection of nodes interconnected by communication links and segments for transporting data between end nodes, such as personal computers and workstations, or other devices. Many types of networks are available, ranging from local area networks (LANs) to wide area networks (WANs). As shown in FIG. 9, an example computer network 900 may comprise a plurality of network devices, such as routers, switches, computers, and the like, interconnected by communication links. For instance, the plurality of network devices may interconnect one or more user devices 910 (or “client devices” 910) which are operable by a user, such as computers, smart phones, tablets, etc. The communication links interconnecting the various network devices may be wired links or shared media (e.g., wireless links) where certain devices may be in communication with other devices, based on distance, signal strength, current operational status, location, and the like. The communication links may interconnect the various network devices in any feasible configuration. One or more servers 920 (e.g., host servers, web servers, databases, and so on) may be in communication with the network 100 and thus to the plurality of client devices 910. Those skilled in the art will understand that any number and arrangement of nodes, devices, links, etc. may be used in a computer network, and the view shown in FIG. 9 is merely a simplified example.

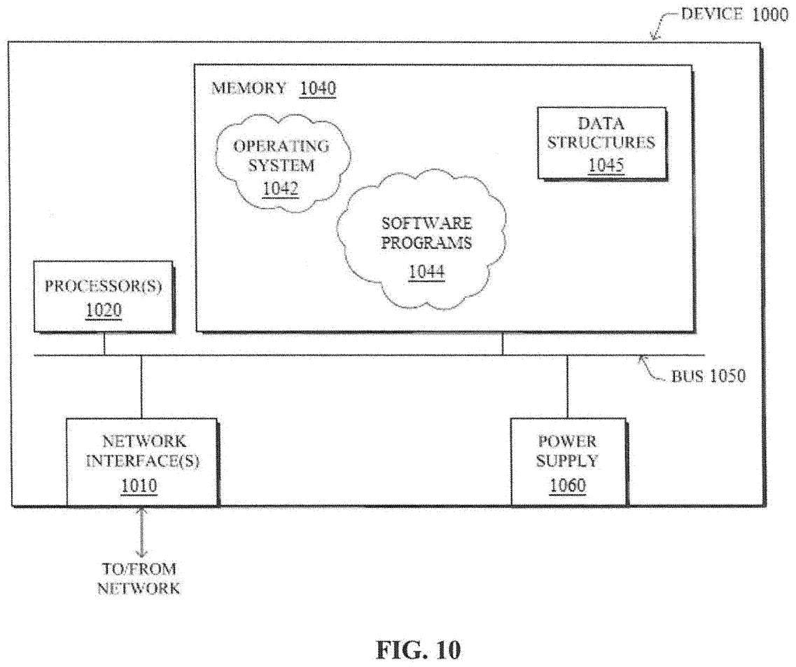

Illustratively, the servers 920 and devices 910 may be configured in any suitable manner, such as the example device 1000 of FIG. 10. For instance, device 1000 may comprise one or more network interfaces 1010 (e.g., wired, wireless, cellular, etc.), one or more processors 1020, a memory 1040, and a power supply 1060 (e.g., plug-in, battery, etc.), interconnected by a system bus 1050. The network interface(s), e.g., ports or transceivers, contain the mechanical, electrical, and signaling circuitry for communicating data over links coupled to the network. The network interfaces may be configured to transmit and/or receive data using a variety of different communication protocols as will be understood by those skilled in the art. Data packets (e.g., traffic and/or messages sent between the devices/nodes of network 900) may be exchanged among the devices of the computer network—via the network interface(s), for example—using predefined network communication protocols, such as certain known wired protocols, wireless protocols, cellular protocols, etc.

The memory 1040 comprises a plurality of storage locations that are addressable by the processor(s) and the network interface(s) for storing software programs and data structures associated with the embodiments described herein. The processor(s) may comprise necessary elements or logic adapted to execute the software programs 1044 and manipulate the data structures 1045 associated with the techniques herein (e.g., operating depending on whether the device 1000 is a device 910 or a server 920, accordingly). An operating system 1042, portions of which are typically resident in memory and executed by the processor, functionally organizes the device by, among other things, invoking operations in support of software processes and/or services executing on the device. These software processes and/or services (programs 1044) may comprise processes (e.g., programs, applications or “apps”, etc.) for use with social media platforms with recognition tokens (or other exchanged units of recognition), as described in greater detail above, e.g., according to whether the device 1000 is a user device, server, database, repository, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, or on specific devices, those skilled in the art will appreciate that processes may be routines or modules within other processes, and that various processes may comprise functionality split amongst a plurality of different devices (e.g., client/server relationships).

In addition, it is expressly contemplated that the components and/or elements described herein may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards, optical data storage devices, and other types of internal or external memory mediums. The computer readable recording medium can also be distributed in network coupled computer systems so that the computer readable media is stored and executed in a distributed fashion.

While there have been shown and described illustrative embodiments that provide for a social media platform with recognition tokens, it is to be understood that various other adaptations and modifications may be made within the spirit and scope of the embodiments herein, with the attainment of some or all of their advantages. For instance, though much of the example above is based on tokens of recognition (e.g., for good deeds, kind tasks, hobbyist achievements, entrepreneurial start-up concepts, innovative inventions, and so on), other types of social media tokens may be based on the techniques herein, and the techniques herein are not limited to merely good deeds or even “recognition” based tokening. In particular, though the techniques herein are based on tokens that are preferably non-monetary, certain alternative embodiments may also be used to tie the recognition tokens to actual monetary value, such as creating an exchange of actual currency, e.g., to one's favorite posts, charities, deeds, challenges, etc. For example, once a user receives/obtains a certain threshold of tokens (e.g., 1000 stars), then that user may be granted the opportunity to dictate a charity into which funds may be allocated (e.g., directing $100 to a “save the pandas” organization). Alternatively or in addition, a user or organization may trade in tokens for monetary rewards, such as trading in 500 stars for $50 in funds, thus creating a type of currency exchange value for the tokens. In such embodiments (as well as others), tokens may also be purchased by users, rather than merely gained for recognition.

Moreover, it should be understood that aspects of the figures depicted herein, such as the depicted functionality, design, terminology, process steps, and the like, are for demonstration purposes only. Thus, the figures merely provide an illustration or the disclosed embodiments and do not limit the present disclosure to the aspects depicted therein.

Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
maintaining, by a computing device, a plurality of token repositories associated with a plurality of social media profiles on a social media platform, the token repositories configured to electronically store an account of recognition tokens allocated to each particular social media profile of the plurality of social media profiles;
receiving, by the computing device, a trigger to transfer a number of recognition tokens from a first token repository associated with a first social media profile to a second token repository associated with a second social media profile;
determining, by the computing device, whether the first token repository contains at least the number of recognition tokens;
in response to the first token repository containing at least the number of recognition tokens, transferring, by the computing device, the number recognition tokens from the first token repository to the second token repository; and
in response to the first token repository containing less than the number of recognition tokens, denying, by the computing device, the transfer of the number recognition tokens from the first token repository to the second token repository.

2. The method as in claim 1, wherein receiving the trigger comprises:
receiving an indication of a clicked recognition icon on a post within a graphical user interface (GUI) of the social media platform from the first social media profile.

3. The method as in claim 1, wherein the number is one.

4. The method as in claim 1, wherein receiving the trigger comprises:
receiving, from the social media platform, an indication that the second social media profile is being awarded a bonus of the number of recognition tokens by the social media platform.

5. The method as in claim 4, wherein the bonus is selected from a group consisting of: a sign-up bonus; a task completion bonus; and a congratulatory bonus.

6. The method as in claim 1, wherein receiving the trigger comprises:
receiving a transfer request from the first social media profile to transfer the number of recognition tokens to the second social media profile.

7. The method as in claim 6, wherein receiving the transfer request comprises:
receiving input from a graphical user interface (GUI) of the social media platform from the first social media profile, the input comprising a selected number of recognition tokens to transfer to the second social media profile as a selected recipient of the transferred recognition tokens.

8. The method as in claim 6, wherein receiving the transfer request comprises:
receiving input from a graphical user interface (GUI) of the social media platform from the first social media profile, the input comprising a selected number of recognition tokens to transfer to a contact of the first social media profile; and
transferring the selected number of recognition tokens to the second social media profile in response to the contact signing up to the social media platform as the second social media profile.

9. The method as in claim 1, wherein the second social media profile is associated with a human user.

10. The method as in claim 1, wherein the second social media profile is associated with an organization.

11. The method as in claim 1, further comprising:
maintaining, with the plurality of social media profiles, a list of badges allocated to each particular social media profile of the plurality of social media profiles; and
allocating the badges based on recognition token activity.

12. The method as in claim 11, wherein the recognition token activity is selected from a group consisting of: surpassing a threshold number of tokens earned; surpassing a threshold number of tokens given; surpassing a threshold number of tokens earned; and surpassing a threshold number of token-earning tasks.

13. The method as in claim 1, wherein receiving the trigger comprises:
receiving an indication of a completion, by the second social media profile, of a token-earning task presented within the social media platform.

14. The method as in claim 13, wherein the token-earning task is created by the first social media profile.

15. The method as in claim 13, wherein the token-earning task is created by a third social media profile, and wherein the first social media profile and first token repository are associated with an administrator account for the social media platform.

16. A tangible, non-transitory computer-readable medium containing program instructions executable by a computer to perform a process, comprising:
maintaining a plurality of token repositories associated with a plurality of social media profiles on a social media platform, the token repositories configured to electronically store an account of recognition tokens allocated to each particular social media profile of the plurality of social media profiles;
receiving a trigger to transfer a number of recognition tokens from a first token repository associated with a first social media profile to a second token repository associated with a second social media profile;
determining whether the first token repository contains at least the number of recognition tokens;
in response to the first token repository containing at least the number of recognition tokens, transferring the number recognition tokens from the first token repository to the second token repository; and
in response to the first token repository containing less than the number of recognition tokens, denying the transfer of the number recognition tokens from the first token repository to the second token repository.

17. The computer-readable medium as in claim 16, wherein process when receiving the trigger comprises:
receiving an indication of a clicked recognition icon on a post within a graphical user interface (GUI) of the social media platform from the first social media profile.

18. The computer-readable medium as in claim 16, wherein process when receiving the trigger comprises:
receiving, from the social media platform, an indication that the second social media profile is being awarded a bonus of the number of recognition tokens by the social media platform.

19. The computer-readable medium as in claim 16, wherein process when receiving the trigger comprises:
receiving a transfer request from the first social media profile to transfer the number of recognition tokens to the second social media profile.

20. The computer-readable medium as in claim 16, wherein process when receiving the trigger comprises:
receiving an indication of a completion, by the second social media profile, of a token-earning task presented within the social media platform.
